(19) United States
(12) Patent Application Publication
(10) Pub. No.: US 2011/0285203 A1
(43) Pub. Date: Nov. 24, 2011

(54) POWER SUPPLY SYSTEM OF ELECTRONIC APPARATUS

(75) Inventor: CHIH-CHUNG SHIH, Tu-Cheng, Taipei Hsien (TW)

(73) Assignee: HON HAI PRECISION INDUSTRY CO., LTD., Tu-Cheng,Taipei Hsien (TW)

(21) Appl. No.: 12/938,509

(22) Filed: Nov. 3, 2010

(30) Foreign Application Priority Data
May 18, 2010 (TW) 99115750

(51) Int. Cl. H02J 9/00; H02J 1/00

(52) U.S. Cl. 307/23

(57) ABSTRACT

A power supply system for providing power to a first and second power consumption components, includes a first and a second voltage converter, a power supply unit, a battery, and a monitoring unit. The power supply unit connects to the first and second voltage converters. The battery is connected to the first and second power consumption components. The monitoring unit is connected to the power supply, and monitors a DC power outputted by the power supply. When the DC power is normal, the monitoring unit instructs the power supply to provide the DC power to the first and second voltage converters. When the DC power is abnormal, the monitoring unit instructs the battery provide power to the first and second power consumption components.

### BACKGROUND

1. Technical Field

The present disclosure relates to power supply systems of electronic apparatuses, and particularly to a power supply system comprising a power backup unit.

2. Description of Related Art

Computers that are plugged into an AC power outlet to supply power to the computer typically include a power supply unit that converts input AC power to DC power. The DC power produced by the power supply is used to drive the various components of the computer. When adequate AC power is not supplied to the power supply unit, the operation of the computer may cease. This, in turn, may lead to data loss and/or damage to components of the computer.

Adequate power may not be supplied to the power supply, for example, due to a power interruption or brown out condition. An uninterruptible power supply (“UPS”) may be attached to the computer in order to supply AC power to the power supply unit in the event AC power is not available from the AC power outlet. A conventional UPS unit is typically configured as a standalone unit that must be installed and maintained separately from the computer with which it is used. However, UPS is often too expensive to be widely used.

Therefore, there is room for improvement within the art to provide a power supply unit which has a cheap power backup unit.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block view of a power supply system of an electronic apparatus in accordance with an embodiment.

FIG. 2 is a block view of a power supply system of an electronic apparatus in accordance with another embodiment.

FIG. 3 is a block view of a battery of FIG. 2.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

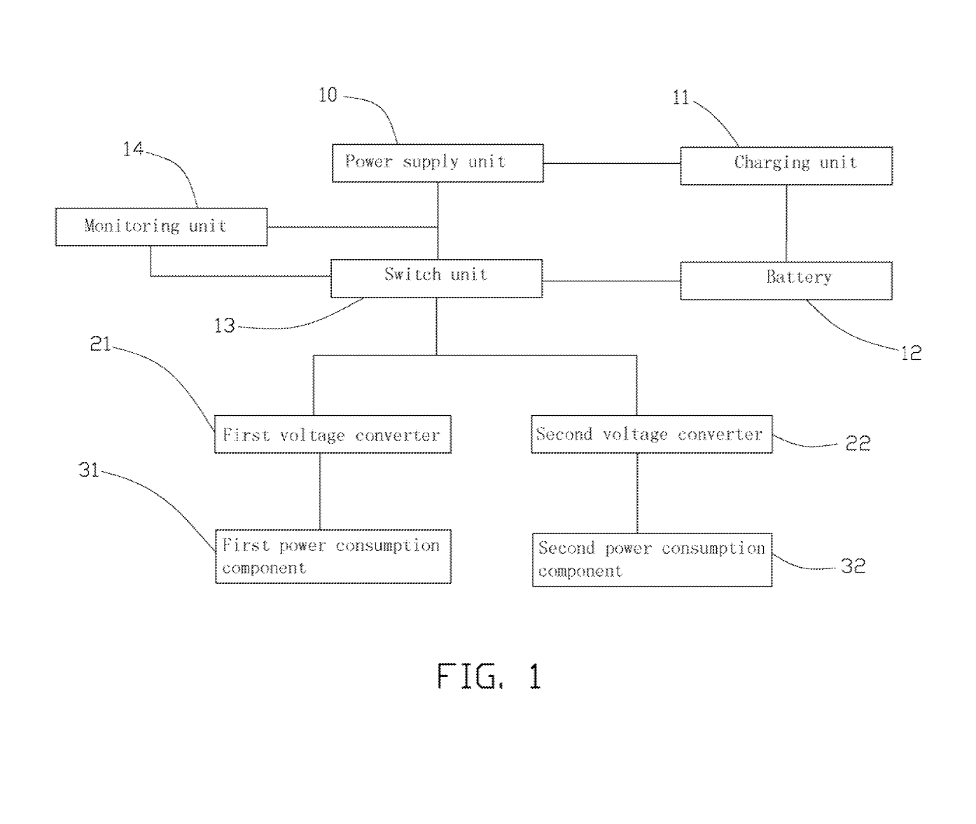

Referring to FIG. 1, a power supply system for an electronic apparatus in accordance with an embodiment, includes a power supply unit 10, a charging unit 11, a battery 12, a switch unit 13, a monitoring unit 14, a first voltage converter 21, and a second voltage converter 22. The power supply system is used to provide power to a first and a second power consumption components 31, 32 of the electronic apparatus.

The power supply unit 10 receives an AC power and converts the AC power into a first DC power to be outputted. The power supply unit 10 connects to the battery 12 by the charging unit 11. When the first DC power of the power supply unit 10 is normal, the charging unit 11 charges the battery 12 by the first DC power. Both of the power supply unit 10 and the battery 12 are connected to the switch unit 13. The switch unit 13 is controlled to have one of the power supply unit 10 and the battery 12 providing power.

The monitoring unit 14 connects to the power supply unit 10 and monitors the first DC power. When the monitoring unit 14 monitors that the first DC power is normal, the monitoring unit 14 controls the switch unit 13 to have the power supply unit 10 provide power to the first and second voltage converters 21 and 22. When the monitoring unit 14 monitors the first DC power as abnormal, the monitoring unit 14 controls the switch unit 13 to have the battery 12 provide power to the first and second voltage converters 21 and 22.

Both of the first voltage converter 21 and the second voltage converter 22 are connected to the switch unit 13. The first voltage converter 21 is connected to the first power consumption component 31. The second voltage converter 22 is connected to the second power consumption component 32. The first voltage converter 21 converts the first DC power of the power supply unit 10 or the power provided by the battery 12 into a first voltage power, which is provided to the first power consumption component 31. The second voltage converter 22 converts the first DC power of the power supply unit 10 or the power provided by the battery 12 into a second voltage power, which is provided to the second power consumption component 32.

When the power supply system of FIG. 1 is working, the monitoring unit 14 monitors whether the first DC power outputted by the power supply unit 10 is normal. If the first DC power is normal, the switch unit 13 is controlled to have the power supply unit 10 provide the first DC power to the first and second voltage converter 21 and 22. Therefore, the first and second power consumption components 31 and 32 are powered and can normally run. Simultaneously, the first DC power of the power supply unit 10 is provided to the charging unit 11. The battery 12 is charged by the charging unit 11. If the first DC power is abnormal, the switch unit 13 is controlled to have the battery 12 provide power to the first and second voltage converters 21 and 22. Therefore, the first and second power consumption components 31 and 32 can also be powered to normally run.

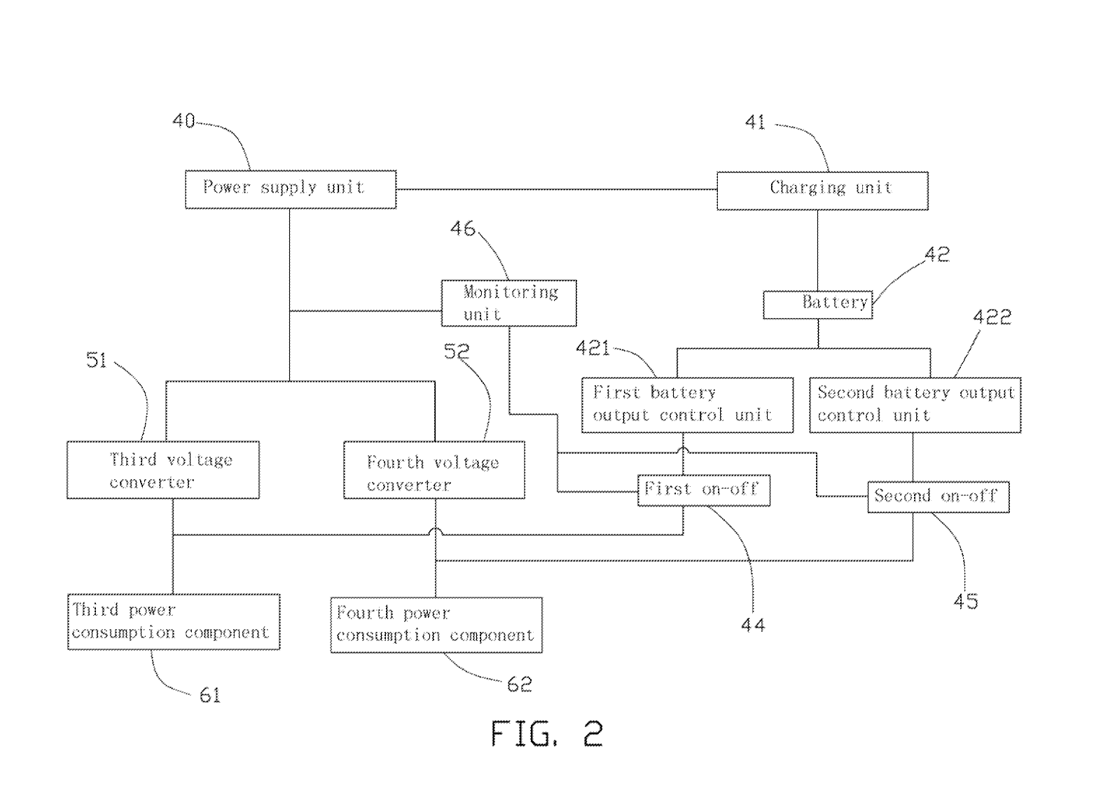

Referring to FIG. 2, a power supply system for an electronic apparatus in accordance with another embodiment, includes a power supply unit 40, a charging unit 41, a battery 42, a first battery output control unit 421, a second battery output control unit 422, a first on-off 44, a second on-off 45, a monitoring unit 46, a third voltage converter 51, and a fourth voltage converter 52. The power supply system of FIG. 2 is used to provide power to a third and a fourth power consumption components 61 and 62 of the electronic apparatus.

The power supply unit 40 receives an AC power and converts the AC power into a second DC power to be outputted. The power supply unit 40 connects to the battery 42 via the charging unit 41. Both of the third and fourth voltage converters 51 and 52 are connected to the power supply unit 40. The third voltage converter 51 is connected to the third power consumption component 61. The fourth voltage converter 52 is connected to the fourth power consumption component 62. The third voltage converter 51 is capable of converting the second DC power into a third voltage power provided to the third power consumption component 61. The fourth voltage converter 52 is capable of converting the second DC power into a fourth voltage power provided to the fourth power consumption component 62.

The battery 42 is connected to the third power consumption component 61 via the first battery output control unit 421 and the first on-off 44. The battery 42 is further connected to the fourth power consumption component 62 via the second battery output control unit 422 and the second on-off 45.

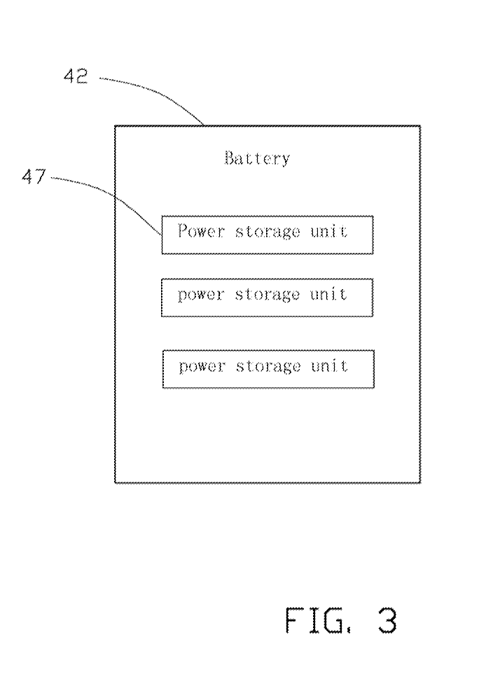

Referring to FIG. 3, the battery 42 comprises a plurality of power storage units 47. The first battery output control unit 421 is capable of connecting the power storage units 47 in a first manner to generate the third voltage power provided to the third power consumption component 61. The second battery output control unit 422 is capable of connecting the power storage units 47 in a second manner to generate the fourth voltage power provided to the fourth power consumption component 62.

When the power supply system of FIG. 2 works, the monitoring unit 46 monitors whether the second DC power outputted by the power supply unit 40 is normal. If the second DC power is normal, the monitoring unit 46 turns off the first on-off 44 and second on-off 45. The second DC power is provided to the third and fourth voltage converters 61, 62. Therefore, the third and fourth power consumption components 61, 62 are powered and can normally run. Simultaneously, the second DC power is provided to the charging unit 41. The battery 42 is charged by the charging unit 41.

If the second DC power is abnormal, the monitoring unit 46 controls the power supply unit 40 stops providing the second DC power. Simultaneously, the monitoring unit 46 turns on the first on-off 44 and second on-off 45. Therefore, the battery 42 provides power to the third and fourth power consumption components 61, 62.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A power supply system of an electronic apparatus for providing power to a first power consumption component and a second power consumption component, the power supply system comprising:
a first voltage converter connected to the first power consumption component, the first voltage converter configured to convert power into a first voltage power, which is configured to provide to the first power consumption component;
a second voltage converter connected to the second power consumption component, the second voltage converter configured to convert power into a second voltage power, which is configured to provide power to the second power consumption component;
a power supply unit and a battery, the power supply unit connected to the first and second voltage converters, and the battery connected to the first and second power consumption components; and
a monitoring unit connected to the power supply and configured to monitor a DC power outputted by the power supply;
wherein when the DC power is normal, the monitoring unit is configured to instruct the power supply to provide the DC power to the first and second voltage converters; when the DC power is abnormal, the monitoring units are configured to instruct the battery to provide power to the first and second power consumption components.

2. The power supply system of claim 1, further comprising a switch unit controlled by the monitoring unit, the power supply unit is connected to the first and second voltage converters via the switch unit, the battery is connected to the first and second power consumption components via the switch unit; the monitoring unit is configured to instruct the switch unit to conduct the power supply with the first and second voltage converters when the DC power is normal and instruct the switch unit to conduct the battery with the first and second power consumption components when the DC power is abnormal.

3. The power supply system of claim 1, further comprising a first battery output control unit and a second battery output control unit, wherein the battery is connected to the first power consumption component via the first battery output control unit, the battery is connected to the second power consumption components via the second battery output control unit, the first battery output control unit is configured to instruct the battery to output the first voltage power, and the second battery output control unit is configured to instruct the battery to output the second voltage power.

4. The power supply system of claim 3, wherein the battery comprises a plurality of power storage units, the first battery output control unit connects the plurality of power storage units in a first manner to output the first voltage power, and the second battery output control unit connects the plurality of power storage units in a second manner to output the second voltage power.

5. The power supply system of claim 3, wherein the first battery output control unit connects to the first power consumption component via a first on-off, the second battery output control unit connects to the second power consumption component via a second on-off, the first on-off and the second on-off are configured to turn off when the DC power is normal, and configured to turn on when the DC power is abnormal.

6. The power supply system of claim 1, further comprising a charging unit connected between the power supply unit and battery, wherein the charging unit is configured to receive the DC power, and configured to charge the battery when the DC power is normal.

7. A power supply system for providing power to a first power consumption component and a second power consumption component, comprising:
a power supply unit configured to output a DC power, the power supply unit connected to the first power consumption component via a first voltage converter, the power supply unit connected to the second power consumption component via a second voltage converter;
a battery connected to the first consumption component via a first battery output control unit, the battery connected to the second consumption component via a second battery output control unit; and
a monitoring unit connected to the power supply unit, the monitoring unit configured to monitor the DC power outputted by the power supply unit;
wherein when the DC power is normal, the monitoring unit is configured to instruct the power supply unit to provide the DC power to the first and second voltage converters, and when the DC power is abnormal, the monitoring unit is configured to instruct the battery to provide power to the first and second voltage converters.

8. The power supply system of claim 7, wherein the first voltage converter is configured to convert the DC power into a first voltage power, which is configured to provide to the first power consumption component, and the second voltage converter is configured to convert the DC power into a second voltage power which is configured to provided to the second power consumption component.

9. The power supply system of claim 7, wherein the battery comprises a plurality of power storage units, the first battery output control unit connects the plurality of power storage units in a first manner to output a first voltage power, which is configured to provide to the first power consumption component, the second battery output control unit connects the plurality of power storage units in a second manner to output a second voltage power, which is configured to provide to the second power consumption component.

10. The power supply system of claim 9, wherein the first battery output control unit connects to the first power consumption component via a first on-off, the second battery output control unit connects to the second power consumption component via a second on-off, the first on-off and the second on-off are configured to turn off when the DC power is normal, and are configured to turn on when the DC power is abnormal.

11. The power supply system of claim 7, further comprising a charging unit connected between the power supply unit and battery, wherein the charging unit is configured to receive the DC power, and configured to charge the battery when the DC power is normal.
